(19) United States
(12) Patent Application Publication
(10) Pub. No.: US 2025/0346165 A1
(43) Pub. Date: Nov. 13, 2025

(54) CUSHION AND A METHOD OF MANUFACTURE

(71) Applicant: Lear Corporation, Southfield, MI (US)

(72) Inventors: Joshua HALLOCK, Warren, MI (US); Michelle A. BRUDZYNSKY, Farmington Hills, MI (US); Ernesto A. VILLARREAL, South Lyon, MI (US); Eric REPKE, Milford, MI (US); David HALE, Northville, MI (US); Mark KARGES, Macomb, MI (US); Bradley DUNCAN, Harrison Twp., MI (US); Lisa SWIKOSKI, West Bloomfield, MI (US)

(21) Appl. No.: 19/176,375

(22) Filed: Apr. 11, 2025

Related U.S. Application Data
(60) Provisional application No. 63/643,470, filed on May 7, 2024.

(30) Foreign Application Priority Data
Aug. 9, 2024 (DK) PA202470214

(51) Int. Cl. B60N 2/70; B29C 70/42; B29L 31/58

(52) U.S. Cl. CPC B60N 2/7035; B29C 70/42; B60N 2/7017; B29L 2031/58

(57) ABSTRACT

A method includes forming a mesh member, forming hinges in the mesh member to form a blank, placing the blank into a mold, and forming a product from the mesh member in the mold. The mesh member comprises a set of filaments of polymeric material, where at least two members of the set of filaments are looped and bonded to each other.

### CROSS-REFERENCE TO RELATED APPLICATIONS

This application claims the benefit of U.S. provisional application Ser. No. 63/643,470, filed May 7, 2024, and priority to Denmark application Serial No. PA 2024 70214 filed Aug. 9, 2024, the disclosures of which are hereby incorporated in their entirety by reference herein.

### TECHNICAL FIELD

This relates to a cushion comprising a filament mesh structure, and a method of manufacture.

### BRIEF DESCRIPTION OF THE DRAWINGS

FIG. 1 is a perspective view of an example of a seat assembly;

FIGS. 2A and 2B are a perspective front view and corresponding a magnified view, respectively, of an example of a cushion of the seat assembly that comprises a filament mesh structure;

FIG. 3 is schematic view of an example of a manufacturing system for making the filament mesh structure;

FIGS. 4A-4C illustrate the manufacturing steps of forming a seat cushion from the filament mesh structure;

FIGS. 5A and 5B illustrate different shaped blanks that may be placed into a mold to form a seat cushion into a desired shape;

FIG. 6 illustrates a molded seat cushion having various features;

FIG. 7 illustrates a B-side of a blank of a seat cushion having V-shaped notches and grooves defined therein;

FIG. 8 illustrates an A-side of a molded seat cushion having V-shaped grooves defined therein;

FIG. 9 illustrates an A-side of a molded seat cushion having an undercut design;

FIG. 10 illustrates a B-side of the molded seat cushion having the undercut design;

FIG. 11 is a cross-sectional view taken along line 11-11 in FIG. 10;

FIG. 12 illustrates an A-side of a molded seat cushion in an unfolded condition;

FIG. 13 illustrates a B-side of the molded seat cushion in the unfolded condition; and

FIG. 14 is a flowchart of a method for forming a product.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a” and “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

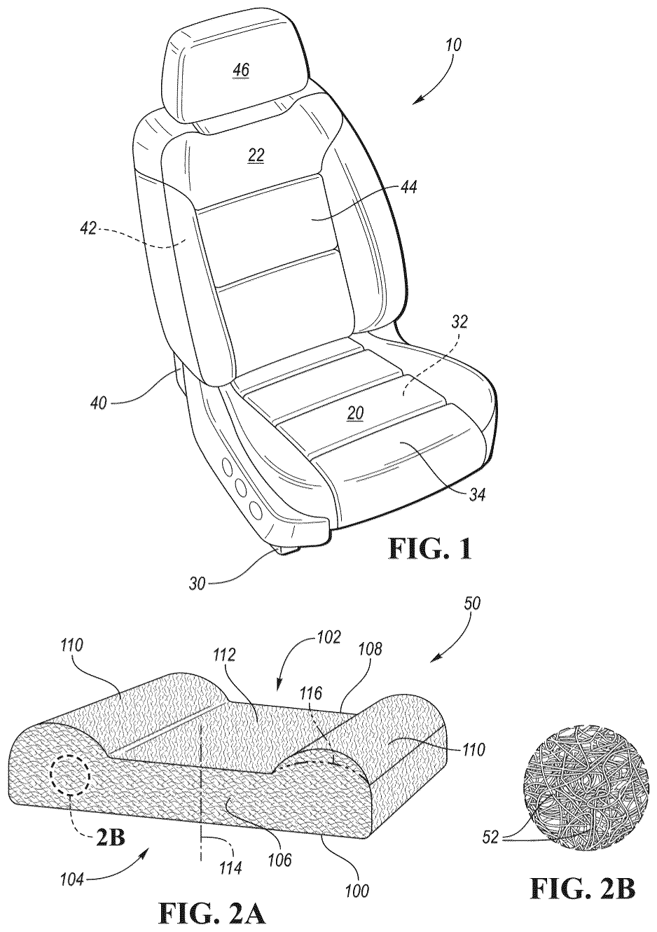

Referring to FIG. 1, an example of a seat assembly 10 is shown. In some embodiments, the seat assembly 10 is a vehicle seat assembly, such as for a land vehicle like a car, truck, bus, or the like, or for a non-land vehicle like aircraft or watercraft. For example, a seat assembly 10 for a land vehicle may be shaped and sized as a front row driver or passenger seat, a second, third, or other rear row seat, and may include bucket-style seats as shown, bench-style seats, or other seat styles. Furthermore, the seat assembly 10 may be a non-stowable seat or a stowable seat that may be foldable and stowable in a cavity in the vehicle floor. Additionally, the seat assembly 10 may be configured for non-vehicle applications such as furniture.

In the configuration shown in FIG. 1, the seat assembly 10 includes a seat bottom 20 and a seat back 22. It is contemplated that the seat back 22 may be omitted in some configurations, such as when the seat assembly 10 is configured as a motorcycle seat or stool.

The seat bottom 20 is configured to receive a seated occupant and support the pelvis and thighs of the seat occupant. The seat bottom 20 includes a seat bottom frame 30, a cushion 32, and a trim cover 34.

The seat bottom frame 30 is a structure that supports the cushion 32. The seat bottom frame 30 includes one or more structural members and may be made of any suitable material, such as a metal alloy, polymeric material, fiber reinforced polymeric material, or combinations thereof. In some configurations, the seat bottom frame 30 includes a panel, seat pan, suspension mat, or suspension wires upon which the cushion 32 is disposed.

The cushion 32 is disposed on the seat bottom frame 30. The cushion 32 is made of a compliant material that supports the seat occupant and distributes load forces from the seat occupant to the seat bottom frame 30. The cushion 32 and associated methods of manufacture will be discussed in more detail below.

The trim cover 34 covers at least a portion of the cushion 32. In addition, the trim cover 34 provides one or more visible exterior surfaces of the seat back 22. The seat occupant may be disposed on the trim cover 34 when seated upon the seat assembly 10. The trim cover 34 is made of any suitable material or materials, such as fabric, leather, leatherette, vinyl, or combinations thereof. The trim cover 34 may include a plurality of trim panels that are assembled in any suitable manner, such as by fusing or stitching. The trim cover 34 is attached to the seat bottom frame 30, the cushion 32, or both. For example, the trim cover 34 may include trim attachment features that are attached to the seat bottom frame 30, the cushion 32, or both, to inhibit removal of the trim cover 34 and help conform the trim cover 34 to the contour of the seat bottom frame 30, the cushion 32, or both.

The seat back 22 is configured to support the back of a seated occupant. The seat back 22 is disposed adjacent to the seat bottom 20. For example, the seat back 22 may be disposed above the seat bottom 20 and near the rear side of the seat bottom 20. The seat back 22 extends in a generally upward direction away from the seat bottom 20. In some configurations, the seat back 22 is mounted to the seat bottom 20 and may be pivotable with respect to the seat bottom 20. In other configurations, the seat back 22 is not mounted to the seat bottom 20. For instance, a vehicle seat back may be mounted to the vehicle body structure, such as in some second row seat assemblies. The seat back 22 includes a seat back frame 40, a cushion 42, a trim cover 44, and optionally a head restraint 46.

The seat back frame 40 is a structure that supports the cushion 42. The seat back frame 40 includes one or more structural members and may be made of any suitable material, such as a metal alloy, polymeric material, fiber reinforced polymeric material, or combinations thereof. In some configurations, the seat back frame 40 includes a panel, pan, suspension mat, or suspension wires upon which the cushion 42 is disposed. It is also contemplated that the seat back frame 40 may be integrally formed with the seat bottom frame 30.

The cushion 42 is disposed on the seat back frame 40. The cushion 42 is made of a compliant material that supports the seat occupant and distributes load forces from the seat occupant to the seat back frame 40. It is contemplated that the cushion 42 may be integrally formed with the cushion 32 of the seat bottom 20 or may be separate from the cushion 32 of the seat bottom 20. The cushion 42 and associated methods of manufacture will be discussed in more detail below.

The trim cover 44 covers at least a portion of the cushion 42. In addition, the trim cover 44 provides one or more visible exterior surfaces of the seat back 22. The seat occupant may be disposed on the trim cover 44 when seated upon the seat assembly 10. The trim cover 44 is made of any suitable material or materials, such as fabric, leather, leatherette, vinyl, or combinations thereof. The trim cover 44 may include a plurality of trim panels that are assembled in any suitable manner, such as by fusing or stitching. The trim cover 44 is attached to the seat back frame 40, the cushion 42, or both. For example, the trim cover 44 may include trim attachment features that are attached to the seat back frame 40, the cushion 42, or both, to inhibit removal of the trim cover 44 and help conform the trim cover 44 to the contour of the seat back frame 40, the cushion 42, or both.

The head restraint 46, if provided, is configured to support the head of a seat occupant. The head restraint 46 is disposed at the top of the seat back 22 or at an end of the seat back 22 that is disposed opposite the seat bottom 20. The head restraint 46 may be moveable in one or more directions with respect to the seat back 22 or may be integrally formed with the seat back 22.

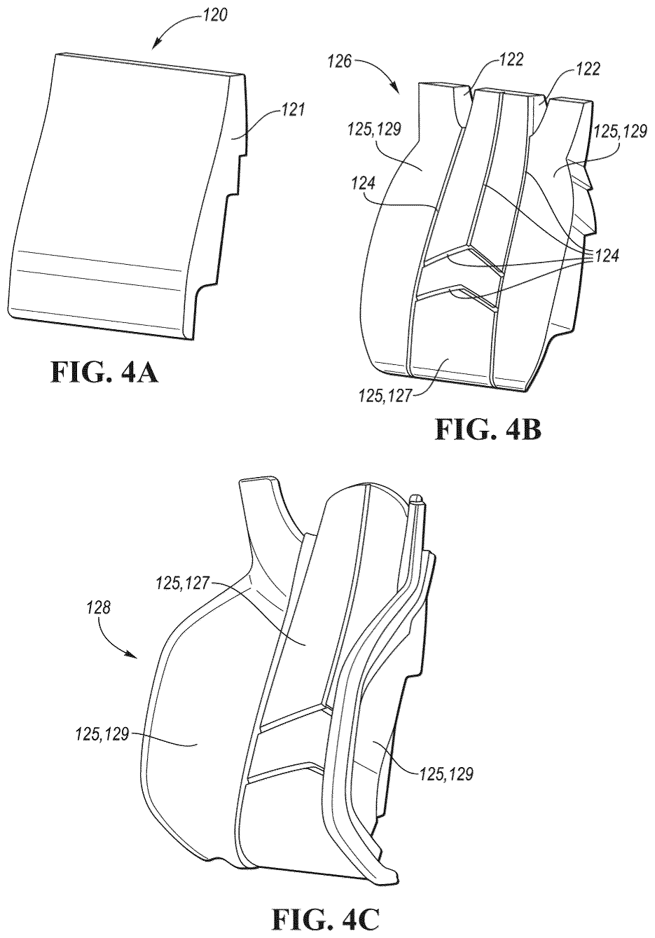

Referring to FIGS. 2A and 2B, an example of a cushion 50 is shown. The cushion in generically designated with reference number 50 for convenience in reference. It is to be understood that the structure and description of the cushion 50 is applicable to the cushion 32 of the seat bottom 20, the cushion 42 of the seat back 22, or both. It is to be further understood that the cushion 50 may take other forms or shapes (e.g., see FIGS. 4A-13).

The cushion 50 is a non-foam component or includes at least one non-foam component. The non-foam component is primarily referred to as a filament mesh structure but may also be referred to as a mesh cushion, mesh structure, or stranded mesh. In FIG. 2, the cushion 50 is depicted as a non-foam component that does not include a foam component or foam material, such as urethane or polyurethane foam; however, it is contemplated that the cushion 50 may also include a foam component or foam material in addition to a non-foam component to provide additional cushioning or localized cushioning for a seat occupant. For example, foam material may be provided between the cushion 50 and a trim cover (e.g., trim cover 34, 44) that is disposed on the cushion 50, within the cushion 50, or combinations thereof. Reducing the amount of foam material that is provided with the cushion 50 or eliminating foam material from the cushion 50 reduces weight, may improve support and comfort of a seat occupant, and may improve recyclability.

The cushion 50 is described below in the context of a cushion 50 that does not include foam material. In this context, the cushion 50 is made of filaments 52 of polymeric material that are randomly looped, bent, curled, or entangled and are bonded together as will be discussed in more detail below. A filament 52 is directed bonded to another filament 52 rather than being indirectly bonded with a resin or other intermediate material.

The filaments 52, which may also be referred to as strands or threads, is made of any suitable material or materials. In some configurations, the filaments 52 are made of a thermoplastic material or thermoplastic material, such as a thermoplastic resin (e.g., molten thermoplastic material or thermoplastic resin) that is polyamide-based, polyester-based, polyimide-based, polyolefin-based, polypropylene-based, polystyrene-based, or combinations thereof. As one example, a polyethylene-based filament may be made of linear low density polyethylene (LLPDE). The filament material may be recyclable unlike foam material or more easily recycled than foam material. It is also contemplated that a filament 52 may comprise reinforcement fibers and that the reinforcement fibers may not be made of a thermoplastic material.

In some configurations, a filament 52 may be a monofilament that is made of a single material. In some configurations, a filament 52 is made of multiple materials. As an example, a filament 52 made of multiple materials may include a core that is made of a first thermoplastic material and a sheath that encircles the core and is made of a second thermoplastic material that differs from the first thermoplastic material. It is contemplated that the cushion 50 may include a combination of monofilaments and filaments that are made of multiple materials and are not monofilaments.

Filaments 52 that are randomly looped, bent, looped, curled, or entangled are bonded together where one filament 52 contacts another filament 52, thereby resulting in a lightweight, air permeable cushion (e.g., cushion 32 and/or 42) or mesh structure comprising a set of filaments 52 having openings or voids between the filaments 52.

The cushion 50 is a manufactured product that comprises a filament mesh structure or body comprising a set of the filaments 52. A cross cross-sectional contour 100 of the cushion 50 comprises a first region 102 and a second region 104. The cross-sectional contour 100 may comprise the outer periphery of the cushion 50 taken along the front end 106 of the cushion 50, the back end 108 of the cushion 50, or any cross-section between the front end 106 and back end 108 of the cushion 50. Such a cross-section between the front end 106 and back end 108 of the cushion 50 may be substantially parallel to either the front end 106 or back end 108 of the cushion 50. Substantially parallel may refer to any range of values that is between exactly parallel and 20° or less from exactly parallel. For example, substantially parallel may refer to a value between 20° and exactly parallel, 15° and exactly parallel, 10° and exactly parallel, 5° and exactly parallel, 1° and exactly parallel, etc.

The first region 102 may be a top region or top surface of the cushion 50 while the second region 104 may be a bottom region or bottom surface of the cushion 50. The first region 102 may include a pair of spaced-apart protrusions 110. The spaced-apart protrusions 110 may comprise or form side bolsters of either a seat bottom 20 or a seat back 22. The spaced-apart protrusions 110 may extend from a centrally positioned region 112 within the first region 102. The centrally positioned region 112 may comprise a substantially flat or substantially planar region or surface. The second region 104 may also comprise a substantially flat or substantially planar region or surface.

Substantially flat or substantially planar may refer to a flat or planar surface that has no deviations from a perfectly flat plane or has deviations from the perfectly flat plane that are less than a tolerance of 10 millimeters (mm). For example, the centrally positioned region 112 may have an allowable tolerance of 10 mm or less, 5 mm or less, 2 mm or less, 1 mm or less, or 0.5 mm or less, 0.25 mm or less, etc. from a corresponding perfectly flat plane.

If the cushion 50 is utilized as cushion 32 of the seat bottom 20, the cushion 50 may be secured to the seat bottom frame 30 such that the spaced-apart protrusions 110 extend away or upward from the seat bottom frame 30. If the cushion 50 is utilized as cushion 42 of the seat back 22, the cushion 50 may be secured to the seat back frame 40 such that the spaced-apart protrusions 110 extend away or forward from the seat back frame 40. The cushion 50 may be symmetrical along central axis 114. For example, the front end 106 of the cushion 50, the back end 108 of the cushion 50, or any cross-section between the front end 106 and back end 108 of the cushion 50 may be symmetrical along central axis 114 such that left and right sides of the front end 106 of the cushion 50, the back end 108 of the cushion 50, or any cross-section between the front end 106 and back end 108 of the cushion 50 are mirror images of each other. Alternatively, the cushion 50 may not be symmetrical along central axis 114. For example, one of the spaced-apart protrusions 110 may be smaller than the other of the spaced-apart protrusions 110 in the event asymmetrical side bolsters of either seat bottom 20 or seat back 22 are desired. Phantom line 116 illustrates a scenario where one of the spaced-apart protrusions 110 is shorter or smaller than the other of the spaced-apart protrusions 110 (e.g., one of the spaced-apart protrusions 110 extends a shorter distance away from the centrally positioned region 112 relative to the other of the spaced-apart protrusions 110).

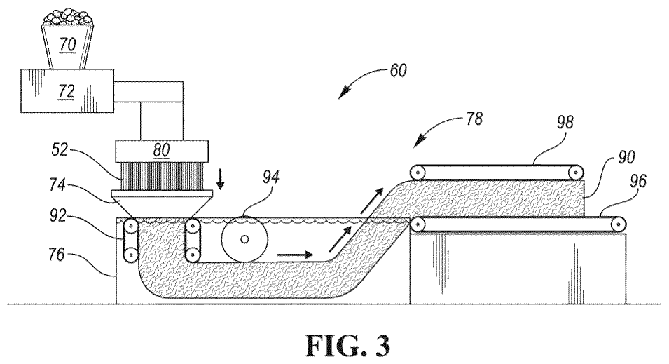

An example of a manufacturing system 60 of making a cushion or filament mesh structure (e.g., cushion 50) is also shown in FIG. 3. In this example, the manufacturing system 60 includes a material supply 70, an extruder 72, and a funnel 74. The manufacturing system 60 also includes a fluid or cooling tank 76 and a material handling subsystem 78.

Referring to FIG. 3, the material supply 70 holds material stock that is to be extruded, such as solid beads, flakes, granules, pellets, or powder made of the material. In some configurations, the material supply 70 is configured as a container or hopper. The material supply 70 provides material stock to the extruder 72.

The extruder 72, which may also be referred to as a first tool, melts the material stock and extrudes the material stock into a set of filaments 52. The extruder 72 may have any suitable configuration. In some configurations, the extruder 72 includes a barrel that receives a rotatable screw and heating elements. Rotation of the screw forces the material to move through the barrel and helps heat the material due to the friction generated as the screw rotates. The material exits the barrel under pressure and in a molten state and is transported to a die 80 of the extruder 72.

The die 80, which may also be referred to as a die plate or extrusion die, has multiple through holes or filament forming openings through which the molten material passes. A single filament 52 is extruded from each through hole. The filaments 52 fall downward from the die 80 under the force of gravity into the funnel 74.

The funnel 74 consolidates or groups the filaments 52 into a more compact arrangement in which the filaments bend, curl, or loop and each filament 52 contacts and bonds to at least one other filament 52. The funnel 74 has an inlet opening or funnel inlet and an outlet opening or funnel outlet that is smaller than the funnel inlet. Individual separated filaments 52 enter the funnel inlet. The filaments 52 bend, curl, or loop and move into contact as they accumulate. The filaments 52 move through the funnel 74 toward the funnel outlet. Some filaments may slide along the funnel 74 or an intervening sheet that is disposed on the funnel 74 as the filaments move toward the funnel outlet. Bonds are formed between filaments 52 at the points of contact while openings or voids between filaments 52 are present at other locations where one filament 52 does not contact or bond to another filament 52. The entangled and bonded filaments 52 pass through the funnel outlet of the funnel 74 and enter the cooling tank 76. For convenience in reference, the bonded filaments 52 are referred to as a filament mesh member or a filament mesh structure 90. The funnel 74 may be a die or may operate as a die that to form a product (e.g., the filament mesh structure 90) from molten material (e.g., the filaments 52 in a molten state).

The cooling tank 76 holds a liquid, such as water or a mixture of water and another fluid. The liquid in the cooling tank 76 helps support the entangled and bonded filaments 52 to limit further compacting or consolidation of the filaments 52 into a less open or less porous arrangement and maintains a desired porosity and density of the filament mesh structure 90. Thus, the liquid provides some buoyancy or resistance that can result in additional bending, curling, or looping of the filaments 52 adjacent to the surface of the liquid or within the funnel 74 to further build the filament mesh structure 90. The liquid also cools the filaments 52 when the filaments 52 are in the liquid. For instance, the liquid cools the filaments 52 from the outside to solidify the filaments 52 and prevent the filaments from bonding at additional locations. At this point, the filaments 52 are relatively stiff and no longer in a plastic state and thus generally maintain a shape and are not moldable or reformable without being reheated.

The material handling subsystem 78 transports the filament mesh structure 90 through the cooling tank 76. The material handling subsystem 78 includes various rollers and conveyors that help move the filament mesh structure 90 through the liquid and out of the liquid. In some configurations, one or more conveyors, tractors, or tractor conveyors 92 are provided in the cooling tank 76 to help pull the filament mesh structure 90 away from the funnel 74 and into the cooling tank 76, and to counter buoyancy of the filaments 52. More specifically, the one or more tractor conveyors 92 may include first and second spaced-apart tractor conveyors 92, where the first and second spaced-apart tractor conveyors 92 are disposed on opposing or opposite sides of the filament mesh structure 90, and are configured to engage the opposing side of the filament mesh structure 90 to help pull the filament mesh structure 90 away from the funnel 74 and into the cooling tank 76.

One or more other rollers, such as roller 94, keep the filament mesh structure 90 submerged in the liquid and guide the filament mesh structure 90 through the cooling tank 76. For example, the roller 94 may guide the filament mesh structure 90 toward a conveyor belt 96 and shaker table 98 that are disposed outside of the cooling tank 76. The shaker table 98 shakes the filament mesh structure 90 while it is on the conveyor belt 96 to remove liquid. Alternatively or in addition, the filament mesh structure 90 may be squeezed to remove liquid, air may be blown toward the filament mesh structure 90 to help remove liquid, the filament mesh structure 90, or both. It is also contemplated that the filament mesh structure 90 may also be allowed to drip dry, or dry in ambient air.

The manufacturing system 60 described above is a continuous flow process in which the filament mesh structure 90 is formed as a continuous structure when filament extrusion is not interrupted. Further processing of the filament mesh structure 90 is provided after exiting the cooling tank 76 to cut the filament mesh structure 90 into individual pieces or blanks for individual cushions. Such processing is conducted by a cutting subsystem of the manufacturing system 60. The cutting system may be of any suitable type. For instance, the cutting system may employ a blade, knife, hot knife, saw, fluid jet, or the like to cut the filaments 52 of the filament mesh structure 90 into a blank. The cutting system may be used to shape or contour the blank. It is also contemplated that a blank may be further shaped or contoured with other manufacturing processes, such as molding of the entire blank or a portion thereof.

Referring to FIG. 4A-4C the manufacturing steps of forming a seat cushion (e.g., a seat bottom cushion or a seat back cushion) from the filament mesh structure 90 is illustrated. First an extrusion 120 having a two-dimensional profile 121 is formed from the filament mesh structure 90. Next, notches 122, grooves 124, and other openings, voids, orifices, channels or apertures are defined or cut into the extrusion 120 to form a blank 126. The notches 122, grooves 124, and other openings, voids, orifices, channels or apertures may define fold lines or hinges (e.g., living hinges) where the material of the blank 126 is shifted or folded during a molding process. Such hinges, or living hinges, may each correspond to a narrowed region of material that is disposed along or adjacent to the notches 122, grooves 124, or other openings, where the narrowed region of material is also disposed between two larger regions of material such that the two larger regions are material are separated by and moveable (e.g., pivotable or rotatable) relative to each other along the narrowed region of material. Next, the blank 126 is placed into a die or mold where the final product (e.g., a seat cushion 128, such as a seat bottom cushion or a seat back cushion) is formed.

The extrusion 120, blank 126, and final product (e.g., a seat cushion 128) may be unitary structures. For example, the extrusion 120, blank 126, and final product (e.g., a seat cushion 128) may be single structures having sections or regions formed from a common “block” of material or common piece of unfinished material. The notches 122, grooves 124, and other openings, voids, orifices, channels or apertures may separate the different sections or regions 125 of the mesh member 90, or more specifically may separate the different sections or regions 125 of the blank 126. Ultimately the notches 122, grooves 124, and other openings, voids, orifices, channels or apertures may separate the different sections or regions 125 of the final product (e.g., a seat cushion 128).

The regions 125 that are adjacent to each other are folded towards each other along the notches 122, grooves 124, and other openings, voids, orifices, channels, apertures or hinges such that that the notches 122, grooves 124, and other openings, voids, orifices, channels or apertures are narrowed or closed, and the unitary structure is placed into the desired shape of the final product (e.g., the desired shape of the seat cushion 128, such as a seat bottom cushion or a seat back cushion). The unitary structure, now in the form of the final product (e.g., a seat cushion 128) is conditioned such that the desired shape of the final product is set (e.g., so that the regions 125 that are adjacent to each other remain folded towards each other and do not return to previously existing positions that existing while the unitary structure was in the form of the blank 126. The unitary structure may be conditioned by heat treating or annealing to set the desired shape of the final product (e.g., a seat cushion 128).

The filament mesh structure 90, or more specifically the final product (e.g., a seat cushion 128), may be vehicle seat back cushion. A first of the regions 125 may comprise a central section 127 of the seat back cushion. A second and a third of the regions 125 may comprise side regions or bolsters 129 of the seat back cushion. In the final product, the regions 125 may lie in different planes relative to each other. For example, exterior surfaces of the regions 125 may positioned at angles relative to each other that are less than or greater than 180°.

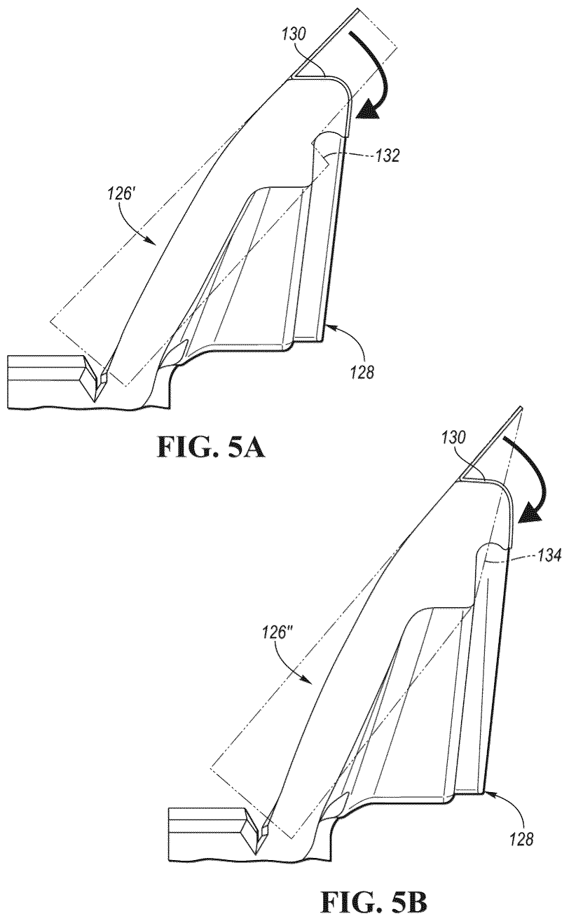

Referring to FIGS. 5A and 5B different shaped blanks 126′ and 126″ that may be placed into a mold to form a seat cushion 128 into a desired shape are illustrated. Some parts (e.g., seat cushion 128) may have an aggressive radius 130 which requires skin (e.g., a smooth external surface) all the way around the radius 130 to achieve good quality and proper fill within the mold. This may be achieved by cutting a step 132 or a chamfer 134 into the blank where the radius 130 will be formed in the mold.

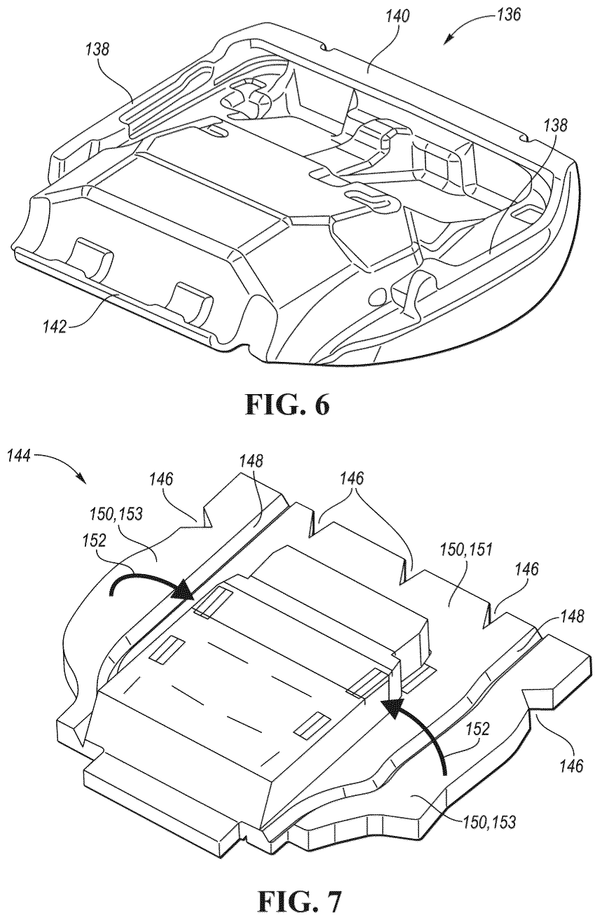

Referring to FIG. 6 a molded seat cushion 136 (e.g., seat bottom cushion or seat back cushion for a vehicle) having various features is illustrated. This seat cushion illustrates a design that has thin side facings 138, noses 140, tails 142, and other features which may be sharp in nature. In this situation (where the cushion has sharp features), the blank forming the cushion may be thin along the sections having the sharp features. These thin sections may be flattened out to be folded into place during the molding process.

Referring to FIG. 7, a B-side of a blank 144 of a seat cushion (e.g., seat bottom cushion or seat back cushion for a vehicle) is illustrated. The B-side may refer to the side of the seat cushion that is attached to a corresponding frame. The blank 144 has V-shaped notches 146 and V-shaped grooves 148 defined therein. The notches 146 and grooves 148 operate to prevent material from bunching up during the molding process, which could form wrinkles in the final product (e.g., the formed seat cushion). The grooves 148 may operate as hinges or hinge points and facilitate folding along specific sections or regions 150 as demonstrated by arrows 152. Such regions 150 that are folded during the molding process may include top ends, bottom ends, sides (e.g., bolsters), etc. of the formed seat cushion.

The blank 144 may be formed into a final product (e.g., a seat cushion) in the same manner as described above with respect to FIGS. 4A-4C. The filament mesh structure 90, or more specifically the final product, may be a vehicle seat bottom cushion. A first of the regions 150 may comprise a central section 151 of the seat bottom cushion. A second and a third of the regions 150 may comprise side sections or bolsters 153 of the seat bottom cushion. In the final product, the side sections or bolsters 153 may be folded relative to the central section 151 such that the regions 150 lie in different planes relative to each other. For example, exterior surfaces of the regions 150 may positioned at angles relative to each other that are less than or greater than 180°.

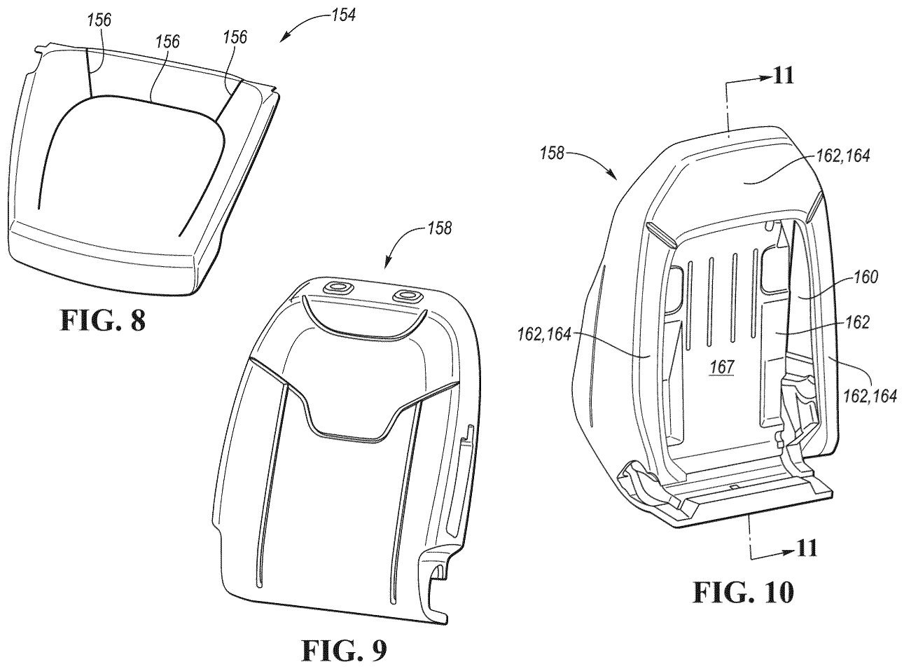

Referring to FIG. 8, an A-side of a molded seat cushion 154 (e.g., seat bottom cushion or seat back cushion for a vehicle) is illustrated. The A-side may refer to the side of the seat cushion 154 that is not attached to a corresponding frame, faces away from the corresponding frame, and is configured to contact an individual who is sitting on or otherwise engaging the seat cushion 154. If a part (e.g., seat cushion 154) is aggressively concave, wrinkles could be formed on the A-side where material is being forced together. Strategic V-shaped notches or V-shaped grooves 156 may be added to the A-side of the blank forming the part (e.g., seat cushion 154), effectively removing additional material or skin prior to molding the part where the wrinkles are known to develop. During the molding process where the blank defining the V-shaped notches or V-shaped grooves 156 is molded into the final product (e.g., seat cushion 154), the V-shaped notches or V-shaped grooves 156 may be closed and may appear as seams or may not be visible in the final product.

Referring to FIGS. 9-11, a molded seat cushion 158 having an undercut design is illustrated. FIG. 9 may represent the A-side of the molded seat cushion 158, while FIG. 10 may represent the B-side the molded seat cushion 158. The B-side may refer to the side of the seat cushion 158 that is attached to a corresponding frame, while the A-side may refer to the side of the seat cushion 158 that is not attached to a corresponding frame, faces away from the corresponding frame, and is configured to contact an individual who is sitting on or otherwise engaging the seat cushion 158.

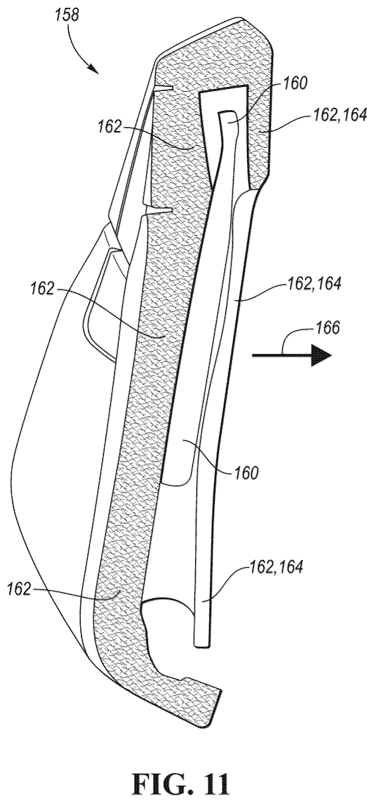

The undercut design of the seat cushion 158 includes voids 160 that are sandwiched between at least two regions 162 of the seat cushion 158. Some of the regions 162 may include overhanging sections or overhangs 164 that overhang one of the voids 160. Undercut is a term that may be used when a portion (e.g., the overhangs 164) of a part is cutting back on itself, relative to the tool direction (illustrated by arrow 166 in FIG. 11). The overhangs 164 may be referred to undercut regions. The tool direction may be the direction of disengagement of the tool forming the seat cushion 158 (e.g., a mold or die). Alternatively, the tool direction may be the direction of engagement of the tool forming the seat cushion 158, which is opposite to arrow 166. The tool direction may refer to both the direction of engagement and disengagement of the tool forming the seat cushion 158. For seat backs or seat back cushions, a “hooded” design may be utilized (e.g., see FIG. 10 where an outer periphery of the seat cushion 158 along the B-side of the seat cushion 158 forms a continuous overhang 164 that overhangs a central void 167 forming a “hooded” shape or configuration). The tool forming the seat cushion 158 may require additional pieces and movement to avoid interference with the overhangs 164 during engagement and disengagement of the tool.

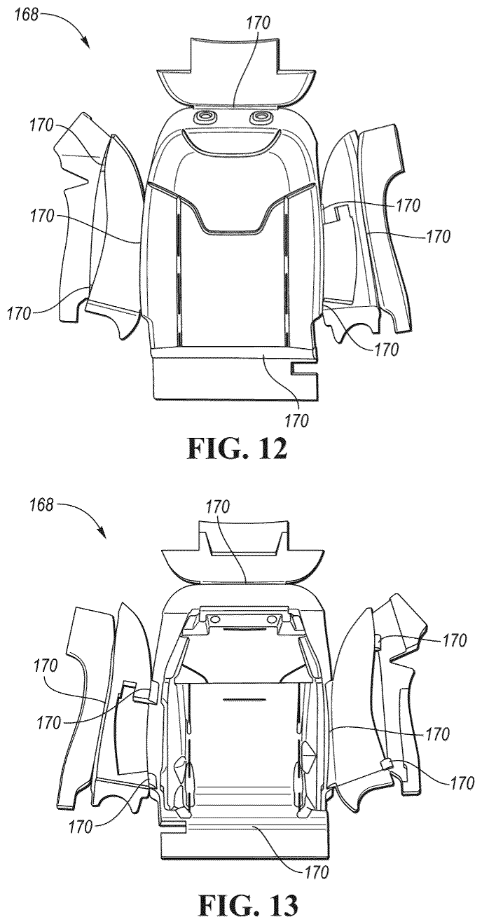

Referring to FIGS. 12 and 13, a molded seat cushion 168 in an unfolded condition is illustrated. FIG. 12 may represent the A-side of the molded seat cushion 168, while FIG. 13 may represent the B-side the molded seat cushion 168. The B-side may refer to the side of the seat cushion 168 that is attached to a corresponding frame, while the A-side may refer to the side of the seat cushion 168 that is not attached to a corresponding frame, faces away from the corresponding frame, and is configured to contact an individual who is sitting on or otherwise engaging the seat cushion 168. The seat cushion 168 may be molded to include notches (e.g., V-shaped notches), grooves (e.g., V-shaped grooves), or other openings, voids, orifices, channels or apertures that may operate as hinges (e.g., living hinges 170) to facilitate folding the molded seat cushion 168 for installation onto a corresponding frame. Alternatively, hinges 170 may be molded into the seat cushion 168 at desired positions. Such a design where the seat cushion 168 is molded in an unfolded state may operate to simplify the tool (e.g., mold or die) forming the seat cushion 168, since there no overhangs present during the molding process that may require additional pieces and movement to avoid interference with such overhangs.

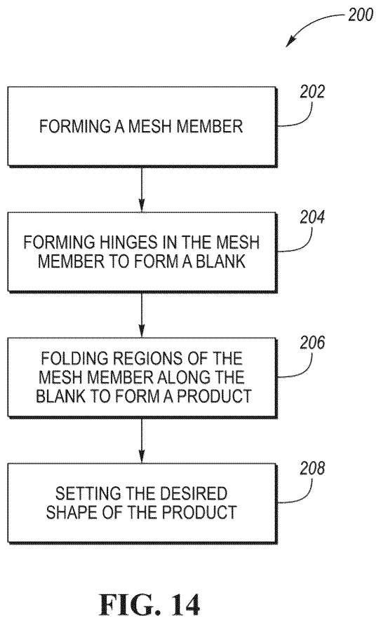

Referring to FIG. 14, a flowchart of a method 200 for forming a product (e.g., seat cushion 128, seat cushion 136, seat cushion formed from blank 144, seat cushion 158, or seat cushion 168) is illustrated. The method 200 begins at block 202 where the filament mesh structure 90 is formed, this may include forming the extrusion 120 as described herein.

Next, the method 200 moves on to block 204, where hinges are formed in the filament mesh structure 90 to form a blank (e.g., blank 126, blank 126′, blank 126″, blank 144, the molded seat cushion 168 in the unfolded condition, etc.). Forming the hinges may include, forming living hinges by cutting the notches 122, grooves 124, or other openings, voids, orifices, channels or apertures into the filament mesh structure 90 as describe herein; by molding hinges into filament mesh structure 90 as described herein; or by any other method known in the art.

The method 200 then moves on to block 206 where the regions (e.g., regions 125, regions 150, etc.) of the blank are folded along the hinges to form the blank into the product (e.g., seat cushion 128, seat cushion 136, seat cushion formed from blank 144, seat cushion 158, or seat cushion 168), which includes forming the product into a desired shape (e.g., the shape of the seat cushion 128 where the various regions 125 are folded such that the various regions 125 lie in different planes as illustrated in FIG. 4C and are no longer coplanar as illustrated in FIG. 4B).

The method 200 then sets the desired shape of the product (e.g., seat cushion 128, seat cushion 136, seat cushion formed from blank 144, seat cushion 158, or seat cushion 168) at block 208. Setting the desired shape of the product may include conditioning or molding the product to set the desired shape. Molding the product may include placing the blank (e.g., blank 126, blank 126′, blank 126″, blank 144, the molded seat cushion 168 in the unfolded condition, etc.) into a die, which may include placing the blank into the die in an unfolded state. The die may then be closed to fold the regions (e.g., regions 125, regions 150, etc.) along the hinges to form the product. Once the die is closed, the product may be heat treated or annealed within the dies to set the desired shape of the product.

Clause 1. A product comprising: a mesh member, the mesh member comprising a set of filaments of polymeric material, wherein at least two members of the set of filaments are looped and bonded to each other, wherein the mesh member comprises a unitary structure that (i) defines a plurality of grooves separating regions within the mesh member, (ii) adjacent regions of the regions are folded towards each other, and (iii) the unitary structure is conditioned.

Clause 2. The product of clause 1, wherein the regions of the mesh member lie in different planes relative to each other.

Clause 3. The product of clauses 1 to 2, wherein the mesh member comprises a vehicle seat back cushion.

Clause 4. The product of clause 3, wherein a first of the regions comprises a central section of the seat back cushion while a second of the regions comprises a bolster of the seat back cushion.

Clause 5. The product of clause 1, wherein the mesh member comprises a vehicle seat bottom cushion.

Clause 6. The product of clause 5, wherein a first of the regions comprises a central section of the seat bottom cushion while a second of the regions comprises a bolster of the seat bottom cushion.

Clause 7. The product of clauses 1 to 6, wherein the mesh member comprises at least one undercut region.

Clause 8. The product of clauses 1 to 7, wherein the mesh member comprises narrowed regions disposed adjacent to the grooves, the narrowed regions separating the regions of the mesh member such that the regions of the mesh member are foldable along the narrowed regions.

Clause 9. A method comprising: forming a mesh member, the mesh member comprising a set of filaments of polymeric material, wherein at least two members of the set of filaments are looped and bonded to each other; forming hinges in the mesh member to form a blank comprising regions separated by the hinges; folding the regions along the hinges to form the blank into a product comprising a desired shape; and molding the product to set the desired shape.

Clause 10. The method of clause 9 further comprising placing the blank into a die.

Clause 11. The method of clauses 9 to 10, wherein the blank is placed into the die in an unfolded state.

Clause 12. The method of clauses 9 to 11 further comprising closing the die to fold the regions along the hinges.

Clause 13. The method of clauses 9 to 12, wherein molding the product to set the desired shape further comprises annealing the product within the die while in a folded state.

Clause 14. The method of clauses 9 to 13 further comprising cutting grooves into the mesh member to form the hinges.

Clause 15. A product comprising: a mesh member, the mesh member comprising a set of filaments of polymeric material, wherein at least two members of the set of filaments are looped and bonded to each other, and wherein the mesh member comprises hinges separating regions of the mesh member such that (i) the regions of the mesh member are foldable along the hinges (ii) adjacent regions of the regions are folded towards each other via the hinges, and (iii) the mesh member is conditioned.

Clause 16. The product of clause 15, wherein the hinges comprise narrowed regions.

Clause 17. The product of clauses 15 to 16, wherein the mesh member comprises a vehicle seat back cushion.

Clause 18. The product of clause 17, wherein a first of the regions comprises a central section of the seat back cushion while a second of the regions comprises a bolster of the seat back cushion.

Clause 19. The product of clause 15, wherein the mesh member comprises a vehicle seat bottom cushion.

Clause 20. The product of clause 19, wherein a first of the regions comprises a central section of the seat bottom cushion while a second of the regions comprises a bolster of the seat bottom cushion.

It should be understood that the designations of first, second, third, fourth, etc. for any component, state, or condition described herein may be rearranged in the claims so that they are in chronological order with respect to the claims. Furthermore, it should be understood that any component, state, or condition described herein that does not have a numerical designation may be given a designation of first, second, third, fourth, etc. in the claims if one or more of the specific component, state, or condition are claimed.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A product comprising:
a mesh member, the mesh member comprising a set of filaments of polymeric material, wherein at least two members of the set of filaments are looped and bonded to each other, wherein the mesh member comprises a unitary structure that (i) defines a plurality of grooves separating regions within the mesh member, (ii) adjacent regions of the regions are folded towards each other, and (iii) the unitary structure is conditioned.

2. The product of claim 1, wherein the regions of the mesh member lie in different planes relative to each other.

3. The product of claim 1, wherein the mesh member comprises a vehicle seat back cushion.

4. The product of claim 3, wherein a first of the regions comprises a central section of the seat back cushion while a second of the regions comprises a bolster of the seat back cushion.

5. The product of claim 1, wherein the mesh member comprises a vehicle seat bottom cushion.

6. The product of claim 5, wherein a first of the regions comprises a central section of the seat bottom cushion while a second of the regions comprises a bolster of the seat bottom cushion.

7. The product of claim 1, wherein the mesh member comprises at least one undercut region.

8. The product of claim 1, wherein the mesh member comprises narrowed regions disposed adjacent to the grooves, the narrowed regions separating the regions of the mesh member such that the regions of the mesh member are foldable along the narrowed regions.

9. A method comprising:
forming a mesh member, the mesh member comprising a set of filaments of polymeric material, wherein at least two members of the set of filaments are looped and bonded to each other;
forming hinges in the mesh member to form a blank comprising regions separated by the hinges;
folding the regions along the hinges to form the blank into a product comprising a desired shape; and
molding the product to set the desired shape.

10. The method of claim 9 further comprising placing the blank into a die.

11. The method of claim 10, wherein the blank is placed into the die in an unfolded state.

12. The method of claim 11 further comprising closing the die to fold the regions along the hinges.

13. The method of claim 12, wherein molding the product to set the desired shape further comprises annealing the product within the die while in a folded state.

14. The method of claim 9 further comprising cutting grooves into the mesh member to form the hinges.

15. A product comprising:
a mesh member, the mesh member comprising a set of filaments of polymeric material, wherein at least two members of the set of filaments are looped and bonded to each other, and wherein the mesh member comprises hinges separating regions of the mesh member such that (i) the regions of the mesh member are foldable along the hinges (ii) adjacent regions of the regions are folded towards each other via the hinges, and (iii) the mesh member is conditioned.

16. The product of claim 15, wherein the hinges comprise narrowed regions.

17. The product of claim 15, wherein the mesh member comprises a vehicle seat back cushion.

18. The product of claim 17, wherein a first of the regions comprises a central section of the seat back cushion while a second of the regions comprises a bolster of the seat back cushion.

19. The product of claim 15, wherein the mesh member comprises a vehicle seat bottom cushion.

20. The product of claim 19, wherein a first of the regions comprises a central section of the seat bottom cushion while a second of the regions comprises a bolster of the seat bottom cushion.
